(19) United States
(12) Patent Application Publication
(10) Pub. No.: US 2025/0299116 A1
(43) Pub. Date: Sep. 25, 2025

(54) METHODS AND SYSTEMS OF PROVISIONING A TRAVEL REPORT

(71) Applicant: Daniel Willaim Lowry, Westlake Village, CA (US)

(72) Inventor: Daniel Willaim Lowry, Westlake Village, CA (US)

(21) Appl. No.: 19/088,582

(22) Filed: Mar. 24, 2025

Related U.S. Application Data
(60) Provisional application No. 63/568,891, filed on Mar. 22, 2024.

(51) Int. Cl. G06Q 10/02; G06Q 50/40

(52) U.S. Cl. CPC G06Q 10/025; G06Q 50/40

(57) ABSTRACT

The present disclosure provides a method of provisioning a travel report. Further, the method may include receiving, using a communication device, a user selection data from a user device associated with a user. Further, the user selection data corresponds to a user selection in relation to a travel destination. Further, the method may include generating, using a processing device, a travel report data based on the user selection data. Further, the travel report data corresponds to the travel report in relation to the travel destination. Further, the generating may be further based on an AI module. Further, the method may include transmitting, using the communication device, the travel report data to the user device.

### FIELD OF DISCLOSURE

The present invention relates to the field of data processing. More specifically, the present disclosure relates to systems and methods of provisioning a travel report.

### BACKGROUND

The absence of tailored recommendations, the limited integration of various transportation choices (such as ridesharing and local transit), and the inability to adjust to last-minute adjustments are some of the drawbacks associated with conventional travel planning platforms. Moreover, conventional travel planning platforms often fail to provide real-time, date- and location-customized travel insights. Existing solutions lack tailored recommendations that adapt to specific travel dates and locations; integration of dynamic factors such as real-time weather updates, seasonal events, location-based recommendations, and time-sensitive travel advisories; and the ability to adjust recommendations based on peak vs off-peak seasons for a given location.

Additionally, they might not take into consideration real-time occurrences (such as weather interruptions). Furthermore, a lot of travel planning platforms don't provide straightforward cost comparisons between various services or cover unconventional travel possibilities like eco-friendly routes or off-the-beaten-path locations. Therefore, there is a need for improved systems and methods of provisioning a travel report.

### SUMMARY OF DISCLOSURE

This summary is provided to introduce a selection of concepts in a simplified form, which are further described below in the Detailed Description. This summary is not intended to identify key features or essential features of the claimed subject matter. Nor is this summary intended to be used to limit the claimed subject matter's scope.

The present disclosure provides a method of provisioning a travel report. Further, the method may include receiving, using a communication device, a user selection data from a user device associated with a user. Further, the user selection data corresponds to a user selection in relation to a travel destination. Further, the method may include generating, using a processing device, a travel report data based on the user selection data. Further, the travel report data corresponds to the travel report in relation to the travel destination. Further, the generating may be further based on an AI module. Further, the method may include transmitting, using the communication device, the travel report data to the user device.

The present disclosure provides a system of provisioning a travel report. Further, the system may include a communication device. Further, the communication device may be configured for receiving a user selection data from a user device associated with a user. Further, the user selection data corresponds to a user selection in relation to a travel destination. Further, the communication device may be configured for transmitting a travel report data to the user device. Further, the system may include a processing device. Further, the processing device may be configured for generating the travel report data based on the user selection data. Further, the travel report data corresponds to the travel report in relation to the travel destination. Further, the generating may be further based on an AI module.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of provisioning a travel report, in accordance with some embodiments.

FIG. 4 illustrates a flowchart of a method 400 of provisioning a travel report including generating, using the processing device 704, a destination suggestion data, in accordance with some embodiments.

FIG. 5 illustrates a flowchart of a method 500 of provisioning a travel report including receiving, using the communication device 702, a destination data from the travel database, in accordance with some embodiments.

FIG. 6 illustrates a flowchart of a method 600 of provisioning a travel report including generating, using the processing device 704, a modified travel report data, in accordance with some embodiments.

FIG. 7 illustrates a block diagram of a system 700 of provisioning a travel report, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure relates to an interactive website designed to assist users in selecting travel destinations by leveraging advanced artificial intelligence (AI) technologies, such as those developed by OpenAI or similar entities like Gemini. Upon selection of a destination by the user, the present disclosure prompts an AI to generate a comprehensive travel report encompassing critical aspects such as health and safety guidelines, entertainment options, culinary experiences, historical insights, and forthcoming events relevant to the chosen location. This personalized report is then compiled and delivered to the user in a PDF format via email, streamlining the travel planning process.

In some embodiments, the present disclosure comprises an interactive website that serves as a user-friendly platform for travelers to explore potential destinations for their upcoming journeys. The system integrates with sophisticated AI technologies capable of analyzing vast amounts of data to provide up-to-date and detailed information tailored to the user's travel interests and requirements.

Further, upon visiting the website the users are presented with an intuitive interface that allows them to specify their travel destination preferences. These preferences can be based on various criteria, including geographical regions, types of activities (e.g., cultural, adventure, relaxation), budget constraints, and specific interests (e.g., culinary tours, historical exploration).

In some embodiments, once a destination is selected by the user, the system initiates a query to the integrated AI technology, instructing it to compile a detailed travel report. This report includes:
1. Health and Safety Information: Guidelines and advisories related to travel health, vaccinations, safety tips, and emergency contacts.
2. Entertainment Options: Curated recommendations for local attractions, entertainment venues, cultural experiences, and unique activities specific to the destination.
3. Food and Culinary Experiences: Insights into local cuisine, must-try dishes, recommended restaurants, food safety tips, and culinary tours
4. Historical Information: An overview of the destination's history, significant landmarks, museums, and heritage sites.
5. Events: Information on upcoming events, festivals, exhibitions, and activities happening around the travel dates.
6. Local Transportation: Detailed information on the local transportation options available, including public transit systems, rental services, taxi and rideshare apps, and tips for navigating the area efficiently and safely.
7. Accommodation Options: A curated selection of places to stay, ranging from hotels and resorts to local guesthouses and Airbnb options, including price ranges, amenities, and proximity to key attractions.
8. Language and Culture: Insights into the local language, basic phrases for travelers, cultural norms, etiquette, and tips for respectful interaction with locals.
9. Weather and Packing Tips: Seasonal weather patterns, what to expect during the travel dates, and suggestions on what to pack accordingly.
10. Connectivity and Technology: Information on local SIM cards, mobile data plans, Wi-Fi availability, and charging standards to stay connected and powered up.
11. Emergency Services: Detailed information on how to access emergency services, including hospitals, consulates, and legal assistance, should the need arise.
12. Sustainability Practices: Tips on how to travel sustainably, including eco-friendly accommodations, conservation areas, and how to minimize one's carbon footprint while traveling.
13. Local Customs and Festivities: Deep dive into local customs, traditions, and festivities that might be taking place during the travel period, offering a richer cultural experience.
14. Personalized Itineraries: Based on the user's interests and the duration of their stay, offering day-by-day plans that include a mix of popular and off-the-beaten-path attractions.
15. Reviews and Recommendations: Incorporating user-generated content such as reviews, photos, and personal recommendations for services, attractions, and eateries to provide a more authentic and trusted source of information.
16. Safety Ratings: An assessment of the overall safety of the destination, including any areas to avoid, based on current data and reports.
17. Budget Planning: An estimation of daily expenses based on the user's budget and lifestyle preferences, helping travelers manage their finances more effectively during their trip.
18. Healthcare Facilities: Information about the availability and location of healthcare facilities, pharmacies, and clinics, along with any necessary health insurance or vaccination requirements.
19. Visa and Entry Requirements: Detailed information on visa requirements, application processes, and entry conditions for travelers from different countries.
20. A personal travel assistant that will update the Used live as to changes to the travel report and make recommendation based on the user's preferences.

In some embodiments, the AI technology ensures that the report is personalized, taking into account the user's preferences and any special requests submitted through the website. After the report is generated, it is automatically converted into a PDF format and sent to the user's email address provided during the initial interaction with the website.

Further in some embodiments, the present disclosure not only enhances the travel planning experience by providing comprehensive and personalized information but also leverages cutting-edge AI technology to ensure that the data is accurate, relevant, and tailored to each traveler's unique preferences.

In some embodiments, the present disclosure may comprise the following aspects:
1. A method for selecting travel destinations and generating customized travel reports using artificial intelligence.
2. The system according to aspect 1, wherein the AI technology is capable of integrating and analyzing data from various sources to provide up-to-date information on health and safety, entertainment, food, history, and events.
3. The process of automatically converting the AI-generated travel report into a PDF format and delivering it via email to the user.

In some embodiments, the present disclosure revolutionizes the way travelers plan their trips by providing a seamless, interactive platform that leverages AI technology to deliver personalized and detailed travel information, enhancing the overall travel planning and decision-making process.

In some embodiments, the present disclosure is an interactive website that uses advanced AI to help users select travel destinations and generate comprehensive, personalized travel reports. These reports cover a wide range of important travel considerations, including health and safety, entertainment, food, historical insights, and events.

In some embodiments, upon a user specifying their preferences on the website, the AI technology analyzes a vast amount of data to produce detailed, up-to-date travel information tailored to the user's interests. The information is then compiled into a report, converted to PDF, and emailed to the user.

In some embodiments, the present disclosure, may comprise the following key components:
Interactive website platform with a user interface for preference input.
AI technology for data analysis and report generation Data sources for health and safety guidelines, entertainment options, culinary experiences, historical information, events, local transportation, accommodation options, language and cultural insights, weather and packing tips, connectivity options, emergency services, sustainability practices, local customs and festivities, personalized itineraries, user reviews and recommendations, safety ratings, budget planning tools, healthcare facility information, visa and entry requirements.
PDF generation and email delivery system.
A personal travel assistant feature for live updates and recommendations.

In some embodiments, the present disclosure may comprise the following steps:
1. User accesses the website and inputs travel preferences.
2. AI analyzes data to generate a travel report based on specified preferences.
3. The report is compiled with relevant travel information sections.
4. The completed report is converted into a PDF.
5. The PDF is emailed to the user's provided address.
6. A personal travel assistant provides live updates and further recommendations.

In some embodiments, the website interface associated with the present disclosure serves as the entry point for user interaction. The AI component is integrated into the website and is responsible for processing user preferences and querying the various data sources. The generated content is then organized into a structured report by the report compilation system. The PDF generation system formats this information into a document, which is then sent through the email delivery system to the user. The personal travel assistant acts as an ongoing support feature, enhancing the dynamic nature of the travel information with updates and personalized recommendations.

In some embodiments, the present disclosure simplifies the travel planning process by providing a user-friendly platform coupled with sophisticated AI technology to deliver tailor-made travel guides that are comprehensive, current, and catered to individual preferences.

In some embodiments, by integrating travel date and location data, the present disclosure ensures that users receive time- and location-relevant insights, including holiday pricing fluctuations, seasonal attractions, real-time alerts, and local advisories.

In some embodiments, upon receiving a travel date and location input, the present disclosure:
1. Retrieves real-time weather data for the selected travel period and location.
2. Analyzes scheduled events, festivals, and seasonal activities occurring at the specified destination and dates.
3. Determines availability fluctuations (e.g., peak season hotel pricing, transportation availability, local holidays, and special events).
4. Incorporates location-based travel advisories, such as local safety concerns, cultural norms, and transit disruptions.
5. Updates recommendations dynamically if the user modifies their travel dates or location.

Further, by leveraging AI-powered analysis, the present disclosure ensures that travel recommendations remain relevant and accurate based on time- and location-based variables.

In some embodiments, the present disclosure provides a method for provisioning a date- and location-specific travel report. The present disclosure receives user selection data, including travel date and location data, processes real-time weather updates, event schedules, seasonal factors, and local information, and generates a customized travel report tailored to the user's travel dates and destination. The report is then transmitted to the user device, ensuring time- and location-sensitive accuracy. Further, the present disclosure introduces an AI-driven travel report system that dynamically adjusts recommendations based on user travel dates and locations. By integrating real-time insights, the present disclosure enhances the accuracy and relevance of travel planning, addressing the limitations of conventional solutions.

In some embodiments, the present disclosure outlines the technical features of an AI-driven system designed for enhanced performance, scalability, and user satisfaction. The system leverages specified AI models and methodologies to deliver accurate, reliable, and customizable solutions.

In some embodiments, the foundation of the present disclosure lies in the precise definition and implementation of AI algorithms and data sources. Specifically, it employs Natural Language Processing (NLP) for generating comprehensive reports and Machine Learning (ML) for providing personalized recommendations. These techniques ensure transparency, credibility, and efficiency in the AI-driven solutions. Further, some benefits of these AI-driven solutions include:
Clarity: Users gain a thorough understanding of how the AI operates.
Credibility: The exact methodologies used add trustworthiness to the system's outputs.
Precision: By specifying algorithms and data sources, the system ensures accurate and relevant outcomes.

In some embodiments, the present disclosure describes the following features:
1. Data Privacy and Security Measures
   This feature ensures that all user interactions are secure and compliant with regulations through encryption techniques and secure storage solutions for user preferences and data. It is integral to ensuring that sensitive information remains protected from unauthorized access.
2. AI Customization and Learning Capabilities
   Building on the specified AI models, this feature enables dynamic improvements based on user feedback. Users can rate reports and provide insights, allowing the AI to refine its recommendations iteratively for enhanced performance over time.
3. Integration with External APIs
   The present disclosure integrates with third-party APIs such as Google Maps and Booking.com by identifying them through the specified AI models. This integration ensures real-time data retrieval and addresses API rate limits using techniques like caching or multiple provider integration, enhancing data accessibility and accuracy.
4. Legal and Intellectual Property Asserts
   This feature extends intellectual property coverage by allowing assert on novel system elements, including AI adaptability and personalization across various travel segments. It protects the contributions of both users and developers, ensuring all innovations are acknowledged.
5. Output Format Enhancements
   Customizable output formats include hyperlinks for future reference and options for retrievable, printable documents like PDFs, emails, or other formats. This feature enhances user experience by providing flexible and convenient access to information.

Further, by focusing on these features, the system achieves enhanced performance, scalability, and user satisfaction while maintaining simplicity and efficiency in its design. The integration of specified AI models with robust features ensures a comprehensive, reliable, and user-friendly solution.

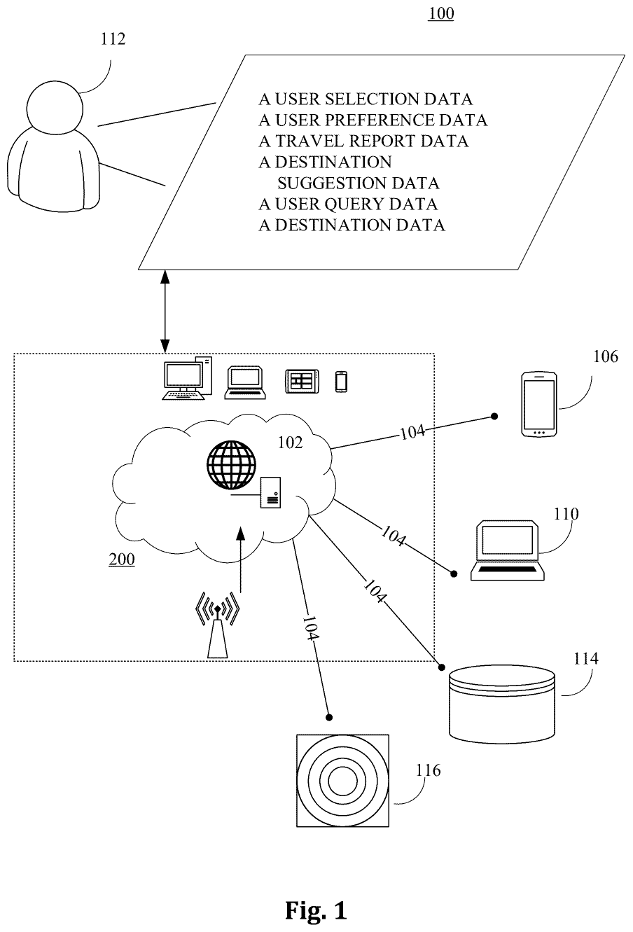

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

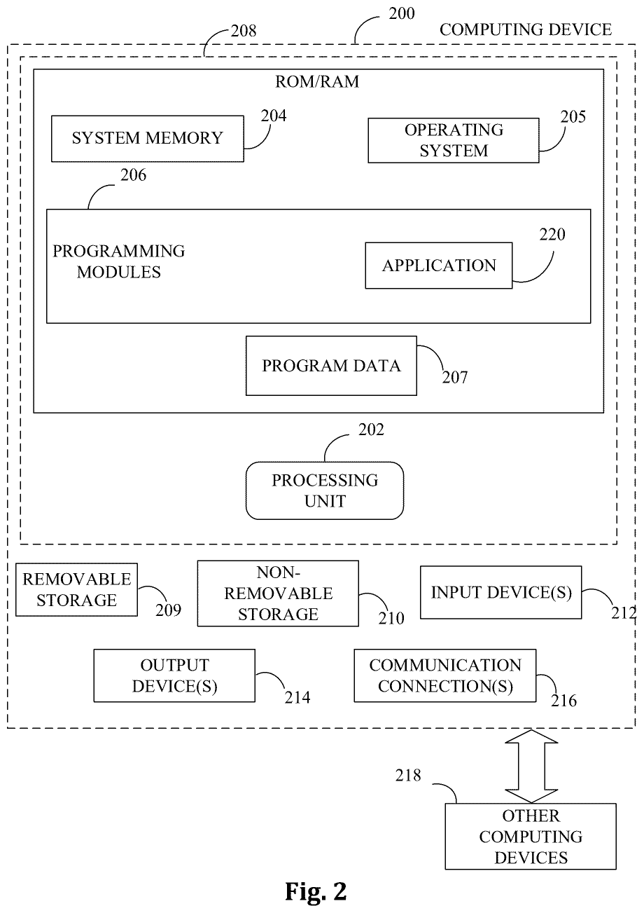

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

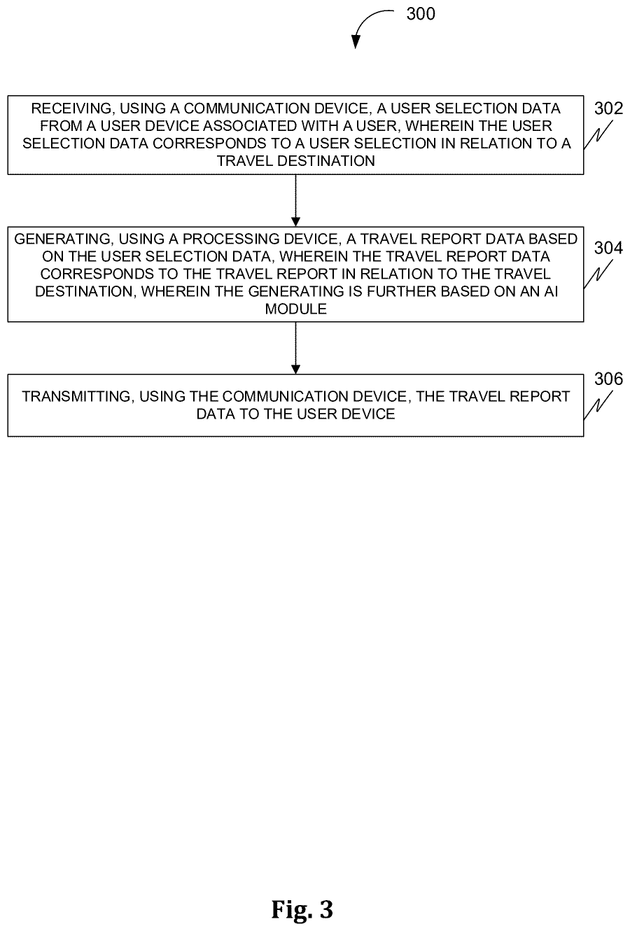

FIG. 3 illustrates a flowchart of a method 300 of provisioning a travel report, in accordance with some embodiments.

Accordingly, the method 300 may include a step 302 of receiving, using a communication device 702, a user selection data from a user device associated with a user. Further, the user selection data corresponds to a user selection in relation to a travel destination. Further, the method 300 may include a step 304 of generating, using a processing device 704, a travel report data based on the user selection data. Further, the travel report data corresponds to the travel report in relation to the travel destination. Further, the generating may be further based on an AI module. Further, the method 300 may include a step 306 of transmitting, using the communication device 702, the travel report data to the user device.

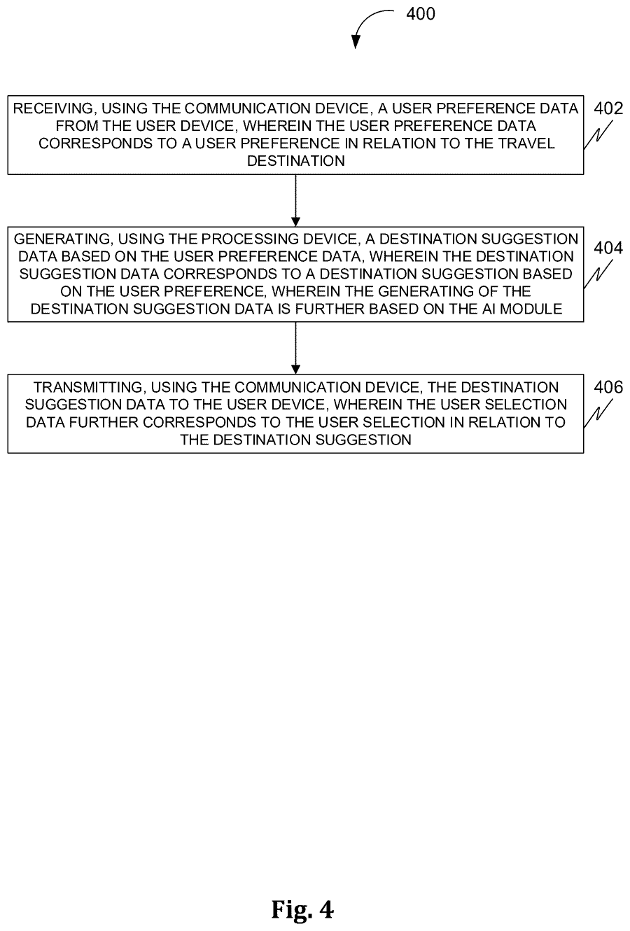

FIG. 4 illustrates a flowchart of a method 400 of provisioning a travel report including generating, using the processing device 704, a destination suggestion data, in accordance with some embodiments.

Further, in some embodiments, the method 400 further may include a step 402 of receiving, using the communication device 702, a user preference data from the user device. Further, the user preference data corresponds to a user preference in relation to the travel destination. Further, in some embodiments, the method 400 further may include a step 404 of generating, using the processing device 704, a destination suggestion data based on the user preference data. Further, the destination suggestion data corresponds to a destination suggestion based on the user preference. Further, the generating of the destination suggestion data may be further based on the AI module. Further, in some embodiments, the method 400 further may include a step 406 of transmitting, using the communication device 702, the destination suggestion data to the user device. Further, the user selection data further corresponds to the user selection in relation to the destination suggestion.

In some embodiments, the method 400 may further include storing, using a storage device, the user preference data. Further, the generating of the travel report data may be further based on the user preference data.

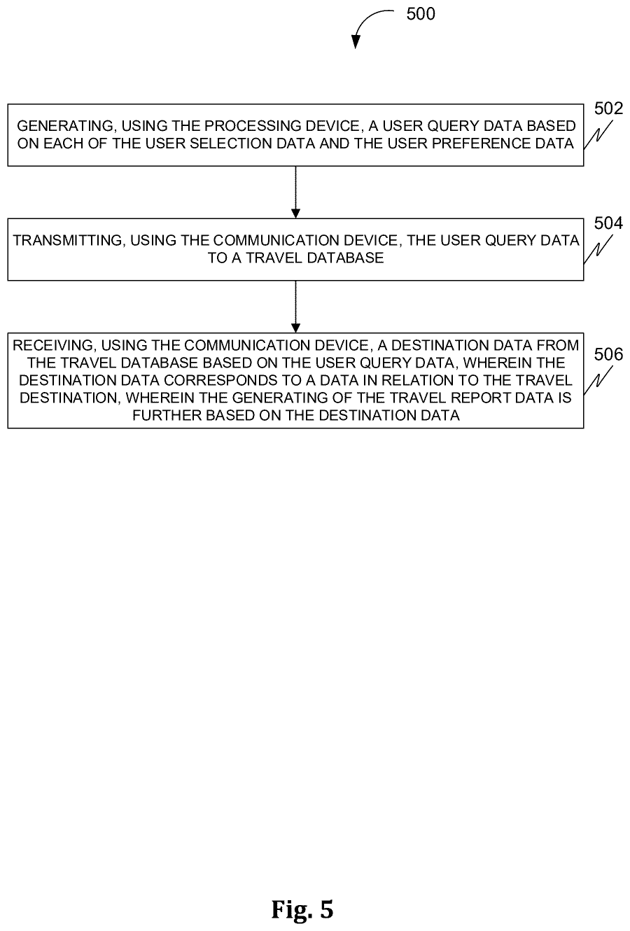

FIG. 5 illustrates a flowchart of a method 500 of provisioning a travel report including receiving, using the communication device 702, a destination data from the travel database, in accordance with some embodiments.

Further, in some embodiments, the method 500 further may include a step 502 of generating, using the processing device 704, a user query data based on each of the user selection data and the user preference data. Further, in some embodiments, the method 500 further may include a step 504 of transmitting, using the communication device 702, the user query data to a travel database. Further, in some embodiments, the method 500 further may include a step 506 of receiving, using the communication device 702, a destination data from the travel database based on the user query data. Further, the destination data corresponds to a data in relation to the travel destination. Further, the generating of the travel report data may be further based on the destination data.

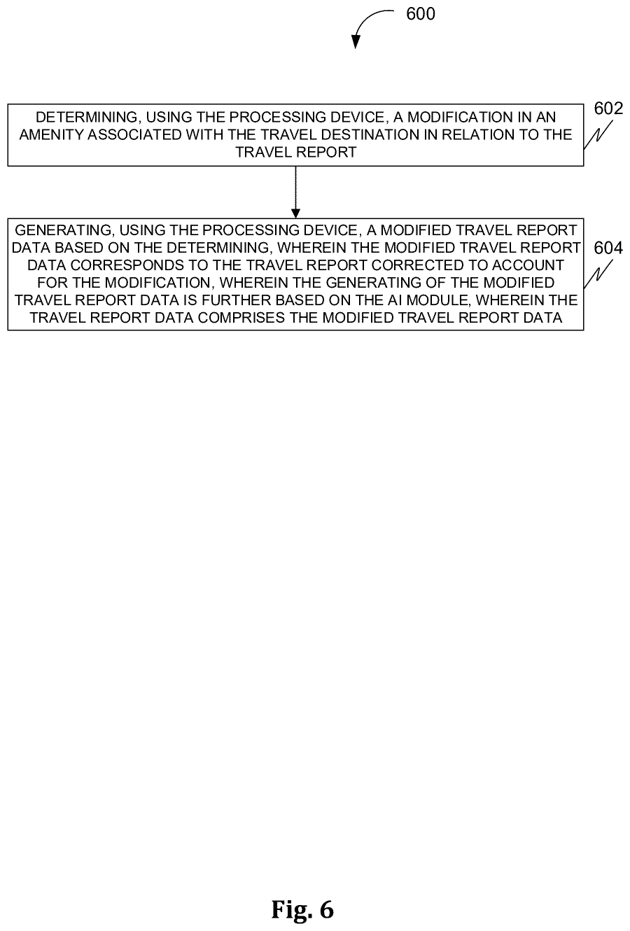

FIG. 6 illustrates a flowchart of a method 600 of provisioning a travel report including generating, using the processing device 704, a modified travel report data, in accordance with some embodiments.

Further, in some embodiments, the method 600 further may include a step 602 of determining, using the processing device 704, a modification in an amenity associated with the travel destination in relation to the travel report. Further, in some embodiments, the method 600 further may include a step 604 of generating, using the processing device 704, a modified travel report data based on the determining. Further, the modified travel report data corresponds to the travel report corrected to account for the modification. Further, the generating of the modified travel report data may be further based on the AI module. Further, the travel report data includes the modified travel report data.

In some embodiments, the user selection data includes one or more of a destination name data and a travel date data. Further, the destination name data corresponds to a name of the travel destination. Further, the travel date data corresponds to a date in relation to a user travel to the travel destination.

In some embodiments, the user preference data includes one or more of a geographical region preference data, a budget preference data, an activity preference data and a user-interest preference data. Further, the geographical region preference data corresponds the user preference in relation to a geographical region. Further, the budget preference data corresponds to the user preference in relation to a budget associated with the travel destination. Further, the activity preference data corresponds to the user preference in relation to an activity associated with the travel destination. Further, the user-interest preference data corresponds to the user preference in relation to a user interest associated with the travel destination.

In some embodiments, the activity preference data includes one or more of a cultural activity data, adventure activity data and a relaxation activity data. Further, the cultural activity data corresponds to a cultural activity associated with the travel destination. Further, the adventure activity data corresponds to an adventure activity associated with the travel destination. Further, the relaxation activity data corresponds to a relation activity associated with the travel destination.

In some embodiments, the user-interest preference data includes one or more of a culinary tour preference data and a historical exploration preference data. Further, the culinary tour preference data corresponds to the user preference in relation to a culinary tour at the travel destination. Further, the historical exploration preference data corresponds to the user preference in relation to an historical exploration.

In some embodiments, the travel report data includes one or more of a health and safety data, an entertainment option data, a culinary insight data, a historical data, a local transportation detail data and an accommodation option data. Further, the health and safety data corresponds to a health and safety insight in relation to the travel destination. Further, the entertainment option data corresponds to an entertainment option recommendation associated with the travel destination. Further, the culinary insight data corresponds to a culinary insight in relation to the travel destination. Further, the historical data corresponds to a history associated with the travel destination. Further, the local transportation detail data corresponds to a detail in relation to a local transportation associated with the travel destination. Further, the accommodation option data corresponds to an accommodation option associated with the travel destination.

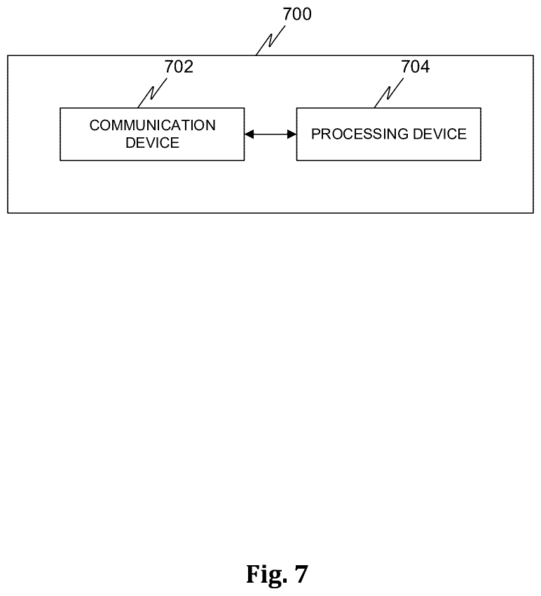

FIG. 7 illustrates a block diagram of a system 700 of provisioning a travel report, in accordance with some embodiments.

Accordingly, the system 700 may include a communication device 702. Further, the communication device 702 may be configured for receiving a user selection data from a user device associated with a user. Further, the user selection data corresponds to a user selection in relation to a travel destination. Further, the communication device 702 may be configured for transmitting a travel report data to the user device. Further, the system 700 may include a processing device 704. Further, the processing device 704 may be configured for generating the travel report data based on the user selection data. Further, the travel report data corresponds to the travel report in relation to the travel destination. Further, the generating may be further based on an AI module.

Further, in some embodiments, the communication device 702 may be further configured for receiving a user preference data from the user device. Further, the user preference data corresponds to a user preference in relation to the travel destination. Further, the communication device 702 may be further configured for transmitting a destination suggestion data to the user device. Further, the user selection data further corresponds to the user selection in relation to the destination suggestion. Further, the processing device 704 may be further configured for generating the destination suggestion data based on the user preference data. Further, the destination suggestion data corresponds to a destination suggestion based on the user preference. Further, the generating of the destination suggestion data may be further based on the AI module.

In some embodiments, the system 700 may further include a storage device which may be configured for storing the user preference data. Further, the generating of the travel report data may be further based on the user preference data.

Further, in some embodiments, the processing device 704 may be further configured for generating a user query data based on each of the user selection data and the user preference data. Further, the communication device 702 may be further configured for transmitting the user query data to a travel database. Further, the communication device 702 may be further configured for receiving a destination data from the travel database based on the user query data. Further, the destination data corresponds to a data in relation to the travel destination. Further, the generating of the travel report data may be further based on the destination data.

Further, in some embodiments, the processing device 704 may be further configured for determining a modification in an amenity associated with the travel destination in relation to the travel report. Further, the processing device 704 may be further configured for generating a modified travel report data based on the determining. Further, the modified travel report data corresponds to the travel report corrected to account for the modification. Further, the generating of the modified travel report data may be further based on the AI module. Further, the travel report data includes the modified travel report data.

In some embodiments, the user selection data includes one or more of a destination name data and a travel date data. Further, the destination name data corresponds to a name of the travel destination. Further, the travel date data corresponds to a date in relation to a user travel to the travel destination.

In some embodiments, the user preference data includes one or more of a geographical region preference data, a budget preference data, an activity preference data and a user-interest preference data. Further, the geographical region preference data corresponds the user preference in relation to a geographical region. Further, the budget preference data corresponds to the user preference in relation to a budget associated with the travel destination. Further, the activity preference data corresponds to the user preference in relation to an activity associated with the travel destination. Further, the user-interest preference data corresponds to the user preference in relation to a user interest associated with the travel destination.

In some embodiments, the activity preference data includes one or more of a cultural activity data, adventure activity data and a relaxation activity data. Further, the cultural activity data corresponds to a cultural activity associated with the travel destination. Further, the adventure activity data corresponds to an adventure activity associated with the travel destination. Further, the relaxation activity data corresponds to a relation activity associated with the travel destination.

In some embodiments, the user-interest preference data includes one or more of a culinary tour preference data and a historical exploration preference data. Further, the culinary tour preference data corresponds to the user preference in relation to a culinary tour at the travel destination. Further, the historical exploration preference data corresponds to the user preference in relation to an historical exploration.

In some embodiments, the travel report data includes one or more of a health and safety data, an entertainment option data, a culinary insight data, a historical data, a local transportation detail data and an accommodation option data. Further, the health and safety data corresponds to a health and safety insight in relation to the travel destination. Further, the entertainment option data corresponds to an entertainment option recommendation associated with the travel destination. Further, the culinary insight data corresponds to a culinary insight in relation to the travel destination. Further, the historical data corresponds to a history associated with the travel destination. Further, the local transportation detail data corresponds to a detail in relation to a local transportation associated with the travel destination. Further, the accommodation option data corresponds to an accommodation option associated with the travel destination.

In some embodiments, the health and safety insight includes one or more of a travel health insight, a vaccination insight, a safety tip insight and an emergency contact insight associated with the travel destination.

In some embodiments, the health and safety data includes one or more of a guideline data and a time-based advisory data. Further, the guideline data corresponds to a rule in relation to the health and safety insight. Further, the time-based advisory data corresponds to an official instruction in relation to the health and safety insight.

In some embodiments, the entertainment option recommendation includes a local attraction recommendation corresponding to a recommendation in relation to a local attraction associated with the travel destination

In some embodiments, the entertainment option recommendation includes an entertainment venue recommendation corresponding to a recommendation in relation to a local attraction associated with the travel destination.

In some embodiments, the entertainment option recommendation includes a cultural experience recommendation corresponding to a recommendation in relation to a cultural experience associated with the travel destination.

In some embodiments, the entertainment option recommendation includes a destination-specific unique activity recommendation corresponding to a recommendation in relation to a unique activity specific to the travel destination.

In some embodiments, the culinary insight includes one or more of a local cuisine, a must-try dish, a restaurant recommendation and a food safety tip associated with the travel destination.

In some embodiments, the historical data includes one or more of a significant landmark data, a museum data and a heritage site data. Further, the significant landmark data corresponds to a significant historical landmark associated with the travel destination. Further, the museum data corresponds to a museum located within the travel destination. Further, the heritage site data corresponds to a heritage site associated with the travel destination.

In some embodiments, the travel report data includes an event data corresponding to an event associated with the travel destination.

In some embodiments, the event includes one or more of a festival and an exhibition associated with the travel destination occurring during the user travel.

In some embodiments, the local transportation detail data includes one or more of a public transit system data and a rental service data. Further, the public transit system data corresponds to a public transit system associated with the travel destination. Further, the rental service data corresponds to the detail in relation to a rental service associated with travel destination.

In some embodiments, the local transportation detail data further includes a rideshare application data corresponding to the detail in relation to a rideshare application based on the travel destination.

In some embodiments, the accommodation option data includes one or more of a price range data, an amenity data and a proximity of key attraction data. Further, the price range data corresponds to a price range associated with the accommodation option.

Further, the amenity data corresponds to an amenity associated with the accommodation option. Further, the proximity of key attraction data corresponds to a proximity of the accommodation option in relation to a key attraction associated with the travel destination.

In some embodiments, the travel report data includes one or more of a language data and a culture data. Further, the language data corresponds to a language associated with the travel destination. Further, the culture data corresponds to each of two or more cultural practices associated with the travel destination.

In some embodiments, the language data includes one or more of a local language data and a basic language phrase data. Further, the local language data corresponds to a local language associated with the travel destination. Further, the basic language phrase data corresponds to two or more basic phrases associated with the local language.

In some embodiments, the travel report data includes a weather data corresponding to a weather forecast associated with the travel destination based on the date in relation to the user travel.

In some embodiments, the weather data includes a seasonal weather pattern data corresponding to a seasonal weather pattern associated with the travel destination based on the user travel.

In some embodiments, the travel report data includes a packing tip data corresponding to a packing tip in relation to the user travel based on the weather forecast associated with travel destination.

In some embodiments, the travel report data includes a connectivity data corresponding to a connectivity detail in relation to the travel destination.

In some embodiments, the connectivity detail includes one or more of a local SIM card information, a mobile data plan information, a Wi-Fi availability information and a charging standards associated with the travel destination.

In some embodiments, the travel report data includes an emergency service data corresponding to an availability of an emergency service in the travel destination.

In some embodiments, the emergency service includes one or more of a hospital, a consulate and a legal assistance.

In some embodiments, the travel report data includes a sustainability practice data corresponding to a sustainability practice associated with the travel destination. Further, the sustainability practice may be intended for the user in relation to the user travel.

In some embodiments, the sustainability practice includes one or more of an adoption of an eco-friendly accommodation, a conservation area associated with the travel destination and a tip to minimize carbon-footprint associated with the user in relation to the user travel.

In some embodiments, the travel report data includes one or more of a local custom data and a local festival data. Further, the local custom data corresponds to a local custom associated with the travel destination. Further, the local festival data corresponds to an occurrence of a local festival associated with the travel destination during the user travel.

In some embodiments, the user preference data includes a user interest data corresponding to a user interest in relation to a user travel. Further, the travel report data includes one or more of a personalized itinerary data corresponding to a personalized itinerary associated with the user travel.

In some embodiments, the personalized itinerary includes a day by day plan in relation to the user travel. Further, the day by day plan may be associated with one or more of a popular and an off-the-beaten-path attraction associated with the travel destination.

In some embodiments, the travel report data includes at least of a review data and a recommendation data. Further, the review data corresponds to a user review associated with an amenity located at the travel destination. Further, the recommendation data corresponds to a user recommendation in relation to the amenity.

In some embodiments, the amenity corresponds to one or more of a key attraction, a service and an eatery associated with the travel destination.

In some embodiments, the user review includes a user photo review corresponding to a user photo in relation to the amenity.

In some embodiments, the travel report data includes a safety rating data corresponding to a safety rating associated with the travel destination.

In some embodiments, the safety rating data includes a region-avoidance data corresponding to an advisory intended for the user in relation to the travel destination. Further, the generating of the safety rating data may be based on one or more of a current data and a report data associated with the travel destination.

In some embodiments, the user preference data includes at last one of a user budget data corresponding to a user budget in relation to the user travel and a user lifestyle preference data corresponding to a user lifestyle. Further, the travel report data includes a travel budget plan data corresponding to a budget plan associated with the user based on the user travel in the travel destination. Further, the generating of the travel budget plan data may be based on each of the user lifestyle preference data and the user budget data.

In some embodiments, the travel report data includes a healthcare facility data corresponding to an availability in relation to the healthcare facility associated with the travel destination.

In some embodiments, the healthcare facility data includes a facility location data corresponding to a location of the healthcare facility.

In some embodiments, the healthcare facility includes one or more of a hospital, a pharmacy and a clinic.

In some embodiments, the healthcare facility data further include one or more of a health insurance requirement data and a vaccination requirement data in relation to the user travel based on the travel destination.

In some embodiments, the travel report data includes an entry requirement data corresponding to an entry requirement in relation to a user entry in the travel destination.

In some embodiments, the entry requirement data includes a visa requirement data corresponding to a visa requirement associated with the travel destination.

In some embodiments, the visa requirement data further includes a visa application procedure data and a visa condition data. Further, the visa application procedure data corresponds to a procedural guide facilitating the application of the visa in relation to the travel destination. Further, the visa condition data corresponds to a condition associated with the application of visa in relation to the travel destination.

In some embodiments, the modified travel report data includes a user notification data corresponding to a user notification in relation to the modification.

In some embodiments, the travel report data may be associated with a format. Further, the format includes a PDF format.

In some embodiments, the destination suggestion data includes a destination list data corresponding to a list of two or more travel destinations.

In some embodiments, the AI module includes two or more AI modules. Further, the two or more AI modules includes one or more of a natural language processing AI module and a machine learning AI module. Further, the generating of the travel report data may be based on the natural language processing AI module. Further, the generating of the destination suggestion data may be based on the machine learning AI module.

In some embodiments, the method 300 may further include identifying, using the processing device 704, a season type based each of the destination name data and the travel date data. Further, the season type corresponds to a type of season in relation to the travel destination. Further, the generating of the travel report data may be further based on the determining of the season type.

In some embodiments, the season type includes one or more of a peak season and an off-peak season. Further, the peak season corresponds to a high demand time in relation to the travel destination. Further, the off-peak season corresponds to a low demand time in relation to the travel destination.

In some embodiments, the method 600 may further include generating, using the processing device 704, an alert data based on the determining of the modification in the amenity associated with the travel destination. Further, the alert data corresponds to an alert in relation to the modification. Further, the modified travel report data includes the alert data.

In some embodiments, the destination data includes a real-time weather data corresponding to a real-time weather detail in associated with the travel destination.

In some embodiments, the travel report data further includes a cultural-norm data corresponding to a cultural norm associated with the travel destination.

In some embodiments, the method 400 may further include training, using the processing device 704, the AI module based on each of the user selection data and the user preference data.

In some embodiments, the method 400 may further include encrypting, using the processing device 704, the user preference data. Further, the storing of the user preference data may be further based on the encrypting.

In some embodiments, the travel report data may be configured to be presented on a user-presentation device associated with the user device. Further, the user device includes a user-input device which may be configured for receiving a user feedback data in relation to the travel report data. Further, the user device further includes a user-communication device which may be configured for transmitting the user feedback data to the communication device 702. Further, the training of the AI module may be further based on the user feedback data.

In some embodiments, the user feedback data includes a travel report rating data corresponding to a rating given by the user in relation to the travel report.

In some embodiments, the user query data includes an API call data representing a request to an API associated with an external travel application. Further, the receiving of the destination data may be further based on the transmitting of the API call data.

In some embodiments, the external travel application includes one or more of a Google Map application, a Booking.com application and a Skyscanner application.

In some embodiments, the method 500 may further include validating, using the processing device 704, the destination data. Further, the generation of the travel report data may be further based on the validating.

In some embodiments, the user travel includes one or more of a business travel, a leisure travel, a family travel and an adventure travel.

In some embodiments, the travel database may be further configured for undergoing a dynamic update in order to incorporate one or more of a real-time change and a real-time modification in relation to the travel destination.

In some embodiments, the travel report data may include a clickable-hyperlink data corresponding to a clickable-hyperlink associated with the travel report. Further, the clickable hyperlink is configured for facilitating one or more of a retrieval operation and a printing operation in relation to the travel report. Further, the printing operation is associated with a format. Further, the format may include the PDF format.

Although the invention has been explained in relation to its preferred embodiment, it is to be understood that many other possible modifications and variations can be made without departing from the spirit and scope of the invention as hereinafter claimed.

1. A method of provisioning a travel report, wherein the method comprising:
receiving, using a communication device, a user selection data from a user device associated with a user, wherein the user selection data corresponds to a user selection in relation to a travel destination;
generating, using a processing device, a travel report data based on the user selection data, wherein the travel report data corresponds to the travel report in relation to the travel destination, wherein the generating is further based on an AI module; and
transmitting, using the communication device, the travel report data to the user device.

2. The method of claim 1 further comprises:
receiving, using the communication device, a user preference data from the user device, wherein the user preference data corresponds to a user preference in relation to the travel destination;
generating, using the processing device, a destination suggestion data based on the user preference data, wherein the destination suggestion data corresponds to a destination suggestion based on the user preference, wherein the generating of the destination suggestion data is further based on the AI module; and
transmitting, using the communication device, the destination suggestion data to the user device, wherein the user selection data further corresponds to the user selection in relation to the destination suggestion.

3. The method of claim 2 further comprises storing, using a storage device, the user preference data, wherein the generating of the travel report data is further based on the user preference data.

4. The method of claim 3 further comprising:
generating, using the processing device, a user query data based on each of the user selection data and the user preference data;
transmitting, using the communication device, the user query data to a travel database; and
receiving, using the communication device, a destination data from the travel database based on the user query data, wherein the destination data corresponds to a data in relation to the travel destination, wherein the generating of the travel report data is further based on the destination data.

5. The method of claim 3 further comprising:
determining, using the processing device, a modification in an amenity associated with the travel destination in relation to the travel report;
generating, using the processing device, a modified travel report data based on the determining, wherein the modified travel report data corresponds to the travel report corrected to account for the modification, wherein the generating of the modified travel report data is further based on the AI module, wherein the travel report data comprises the modified travel report data.

6. The method of claim 1, wherein the user selection data comprises at least one of a destination name data and a travel date data, wherein the destination name data corresponds to a name of the travel destination, wherein the travel date data corresponds to a date in relation to a user travel to the travel destination.

7. The method of claim 2, wherein the user preference data comprises at least one of a geographical region preference data, a budget preference data, an activity preference data and a user-interest preference data, wherein the geographical region preference data corresponds the user preference in relation to a geographical region, wherein the budget preference data corresponds to the user preference in relation to a budget associated with the travel destination, wherein the activity preference data corresponds to the user preference in relation to an activity associated with the travel destination, wherein the user-interest preference data corresponds to the user preference in relation to a user interest associated with the travel destination.

8. The method of claim 7, wherein the activity preference data comprises at least one of a cultural activity data, adventure activity data and a relaxation activity data, wherein the cultural activity data corresponds to a cultural activity associated with the travel destination, wherein the adventure activity data corresponds to an adventure activity associated with the travel destination, wherein the relaxation activity data corresponds to a relation activity associated with the travel destination.

9. The method of claim 7, wherein the user-interest preference data comprises at least one of a culinary tour preference data and a historical exploration preference data, wherein the culinary tour preference data corresponds to the user preference in relation to a culinary tour at the travel destination, wherein the historical exploration preference data corresponds to the user preference in relation to an historical exploration.

10. The method of claim 1, wherein the travel report data comprises at least one of a health and safety data, an entertainment option data, a culinary insight data, a historical data, a local transportation detail data and an accommodation option data, wherein the health and safety data corresponds to a health and safety insight in relation to the travel destination, wherein the entertainment option data corresponds to an entertainment option recommendation associated with the travel destination, wherein the culinary insight data corresponds to a culinary insight in relation to the travel destination, wherein the historical data corresponds to a history associated with the travel destination, wherein the local transportation detail data corresponds to a detail in relation to a local transportation associated with the travel destination, wherein the accommodation option data corresponds to an accommodation option associated with the travel destination.

11. A system of provisioning a travel report, wherein the system comprising:
a communication device configured for:
receiving a user selection data from a user device associated with a user,
wherein the user selection data corresponds to a user selection in relation to a travel destination; and
transmitting a travel report data to the user device; and
a processing device configured for:
generating the travel report data based on the user selection data, wherein the travel report data corresponds to the travel report in relation to the travel destination, wherein the generating is further based on an AI module.

12. The system of claim 11, wherein the communication device is further configured for:
receiving a user preference data from the user device, wherein the user preference data corresponds to a user preference in relation to the travel destination; and
transmitting a destination suggestion data to the user device, wherein the user selection data further corresponds to the user selection in relation to the destination suggestion, wherein the processing device is further configured for generating the destination suggestion data based on the user preference data, wherein the destination suggestion data corresponds to a destination suggestion based on the user preference, wherein the generating of the destination suggestion data is further based on the AI module.

13. The system of claim 12 further comprising a storage device configured for storing the user preference data, wherein the generating of the travel report data is further based on the user preference data.

14. The system of claim 13, wherein the processing device is further configured for generating a user query data based on each of the user selection data and the user preference data, wherein the communication device is further configured for:
transmitting the user query data to a travel database; and
receiving a destination data from the travel database based on the user query data, wherein the destination data corresponds to a data in relation to the travel destination, wherein the generating of the travel report data is further based on the destination data.

15. The system of claim 13, wherein the processing device is further configured for:
determining a modification in an amenity associated with the travel destination in relation to the travel report;
generating a modified travel report data based on the determining, wherein the modified travel report data corresponds to the travel report corrected to account for the modification, wherein the generating of the modified travel report data is further based on the AI module, wherein the travel report data comprises the modified travel report data.

16. The system of claim 11, wherein the user selection data comprises at least one of a destination name data and a travel date data, wherein the destination name data corresponds to a name of the travel destination, wherein the travel date data corresponds to a date in relation to a user travel to the travel destination.

17. The system of claim 12, wherein the user preference data comprises at least one of a geographical region preference data, a budget preference data, an activity preference data and a user-interest preference data, wherein the geographical region preference data corresponds the user preference in relation to a geographical region, wherein the budget preference data corresponds to the user preference in relation to a budget associated with the travel destination, wherein the activity preference data corresponds to the user preference in relation to an activity associated with the travel destination, wherein the user-interest preference data corresponds to the user preference in relation to a user interest associated with the travel destination.

18. The system of claim 17, wherein the activity preference data comprises at least one of a cultural activity data, adventure activity data and a relaxation activity data, wherein the cultural activity data corresponds to a cultural activity associated with the travel destination, wherein the adventure activity data corresponds to an adventure activity associated with the travel destination, wherein the relaxation activity data corresponds to a relation activity associated with the travel destination.

19. The system of claim 17, wherein the user-interest preference data comprises at least one of a culinary tour preference data and a historical exploration preference data, wherein the culinary tour preference data corresponds to the user preference in relation to a culinary tour at the travel destination, wherein the historical exploration preference data corresponds to the user preference in relation to an historical exploration.

20. The system of claim 11, wherein the travel report data comprises at least one of a health and safety data, an entertainment option data, a culinary insight data, a historical data, a local transportation detail data and an accommodation option data, wherein the health and safety data corresponds to a health and safety insight in relation to the travel destination, wherein the entertainment option data corresponds to an entertainment option recommendation associated with the travel destination, wherein the culinary insight data corresponds to a culinary insight in relation to the travel destination, wherein the historical data corresponds to a history associated with the travel destination, wherein the local transportation detail data corresponds to a detail in relation to a local transportation associated with the travel destination, wherein the accommodation option data corresponds to an accommodation option associated with the travel destination.
